(19) United States
(12) Patent Application Publication
(10) Pub. No.: US 2018/0118298 A1
(43) Pub. Date: May 3, 2018

(54) MOTOR-DRIVEN VEHICLE, IN PARTICULAR TWO-WHEELED VEHICLE

(71) Applicant: UJET VEHICLES S.À.R.L., Bertrange (LU)

(72) Inventors: Patrick David, Blaustein (DE); Wolfgang Speiser, Erbach (DE)

(73) Assignee: UJET VEHICLES S.À.R.L., Bertrange (LU)

(21) Appl. No.: 15/564,795

(22) PCT Filed: Apr. 6, 2016
(86) PCT No.: PCT/EP2016/057473

§ 371 Date: Oct. 6, 2017

(30) Foreign Application Priority Data
Apr. 8, 2015 (DE) 10 2015 105 324.1

(51) Int. Cl. B62K 11/06; B62K 21/02; B62K 25/04; B60B 19/00; B62L 1/00; B62M 9/00; B62K 15/00; B62K 19/16

(52) U.S. Cl. CPC B62K 11/06; B62K 21/02; B62K 25/04; B60B 19/00; B62L 1/00; B62M 9/00; B62M 6/75; B62K 19/16; B60Y 2200/126; B62K 2202/00; B62K 2025/048; B60B 2900/111; B62K 2204/00; B62K 15/006

(57) ABSTRACT

Two-wheeled motor-driven vehicles are disclosed. In one embodiment, a two-wheeled motor-driven vehicle includes a chassis, a central unit including a drive unit and a seat carrier, and a cockpit including a steering mechanism and an operating unit. Front and/or rear wheels are carried on respective wheel mounts that rotatably carry the wheels via a roller bearing. The wheel mounts have a first toroidal wheel bearing rim and a second toroidal wheel bearing rim mountable to a wheel rim.

This application is a national stage filing under 35 U.S.C. § 371 of International Application No. PCT/EP2016/057473, filed on Apr. 6, 2016, which claims priority to German Application No. 10 2015 105 324.1, filed on Apr. 8, 2015. Each of these applications is incorporated herein by reference in its entirety.

The present disclosure concerns a motor-driven vehicle, in particular a two-wheeled vehicle, with a chassis, a central unit comprising a drive unit and a seat carrier, having a cockpit structure with a steering mechanism, an operating unit, and wheel mounts front and back with a front wheel and a rear wheel fitted to the wheel mounts.

Compact, relatively lightweight motor-driven vehicles increasingly come into their own in urban traffic in particular not only due to the high volume of traffic and the associated risk of congestion but also due to their flexibility when travelling, for example. In particular, there is a great need for two-wheeled vehicles which can be folded into transportable units, and which are designed to be easy to handle and transport.

According to some aspects, a new concept for such a motor-driven vehicle is offered, in particular a two-wheeled vehicle, with regard to construction and, most importantly, with regard to weight, which brings about significant improvements compared to products which are already on the market.

Some aspects of the current disclosure address the aforementioned problem in that the wheels of such a two-wheeled vehicle, which are fitted to wheel mounts, are hublessly suspended by means of a roller bearing via a toroidal wheel bearing rim on a wheel bearing rim which can be attached to the wheel rim likewise in the shape of a ring.

The major advantages of such a design over known designs with hub wheels are, firstly, that considerable weight can be saved through the hubless design of the wheels and, secondly, that moving the pivot points for the wheel suspension close to the support points of the wheel gives rise to advantages on the road during extension and compression. Furthermore, for such lightweight vehicles, this design has the advantage that the lower unsprung masses of the wheels significantly improve travelling comfort and road hold.

A solution according to some embodiments includes a torsion elastic suspension element, arranged on the wheel bearing rim by means of a mounting flange, possibly comprising an element housing, attached—in one piece or rigidly blocked—to the mounting flange, in which at least one, possibly four evenly distributed rod-shaped torsion elastic suspension elements in the case of an element housing with a basic rectangular shape, are introduced under tension is particularly advantageous. In an embodiment of the subject matter of the current disclosure, the suspension element(s) can be arranged under tension in the element housing by means of an essentially rod-shaped suspension element. Via the suspension core element the suspension element can be attached to the wheel mount by means of a mounting flange on the side facing the wheel mount.

Damping or suspension can be selected or set via the arrangement of the rod-shaped suspension core element in relation to the wheel bearing ring—distance centre suspension core element for the attachment of the mounting flange on the wheel bearing=lever arm for the compression of the wheel—together with the degree of elasticity and the dimensions of the suspension element.

According to some embodiments, the steerable front wheel can be connected to the wheel mount, which is steerable via the steering mechanism, by way of a support element mounted on the toroidal wheel bearing rim on the rim side, such that the notional steering axis runs through the notional centre of the wheel, is particularly advantageous. Such a design ensures that, without significant cost, the same steering movements can be made with a hubless steerable wheel as, conventionally, can be made with hub-mounted steering wheels.

In the case of a vehicle according to some embodiments, brakes such as brake discs, toroidal brake elements can be connected to the wheel rim which interact with brake shoes, which can be attached to the wheel mounts, in an essentially conventional fashion.

The driven rear wheel can comprise a toroidal drive element, which is attached to the rim, and which can be directly or indirectly driven by means of the drive unit. The drive element attached to the rim may be driven by means of an oscillating gear construction to compensate for the movements of the rear wheel.

According to some embodiments, the drive element on the rim side is a gear ring, which can be driven via a toothed belt. However, the drive element on the rim side can also be designed as a toroidal sprocket tooth, which is driven by the drive unit by means of a chain.

In some embodiments, a two-wheeled vehicle is designed as a scooter. The weight advantages of the design according to the invention can be achieved in particular in the case of a folding two-wheeled vehicle, since, due to the special wheel design, the low weight offers the ideal prerequisites for such a vehicle to have a purely electrical drive.

To take full advantage of the weight advantages, it is appropriate to design the essential components of such a vehicle, e.g. chassis, central unit for accommodating the drive, cockpit structure as well as wheel mounts as a fibre reinforced structure.

A motor-driven two-wheeled vehicle assembled in accordance with the current disclosure is shown in the drawing. The characteristics and details of the subject matter of the current disclosure are explained in more detail below with the aid of this embodiment and its details.

In the drawing:

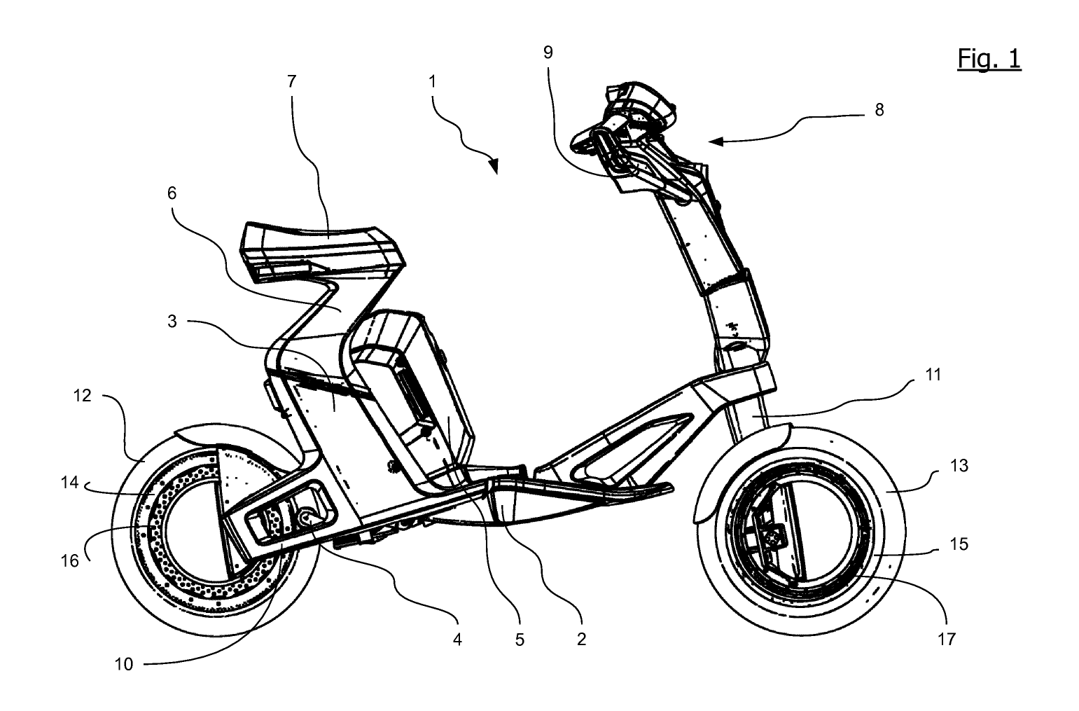

FIG. 1 shows a side view of a motor-driven vehicle according to one embodiment;

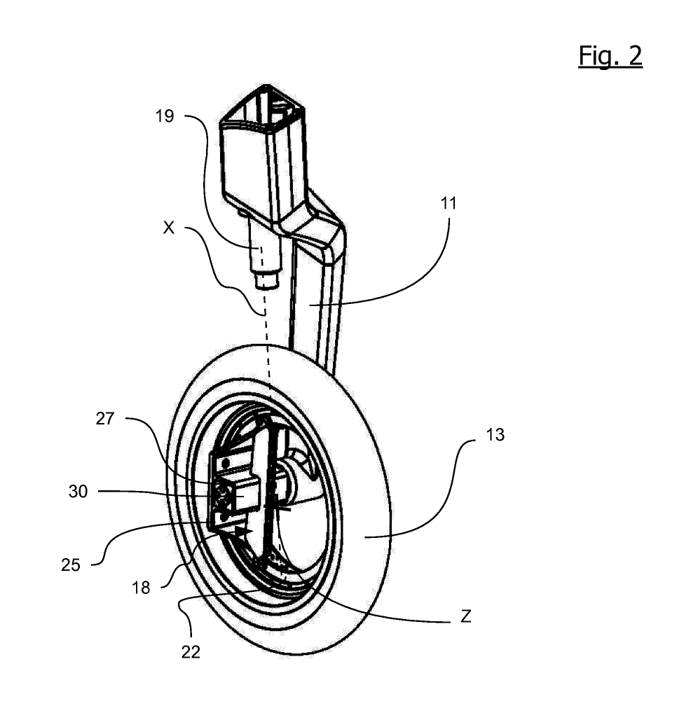

FIG. 2 shows the hubless front wheel of a motor-driven two-wheeled vehicle according to one embodiment with the front wheel mount;

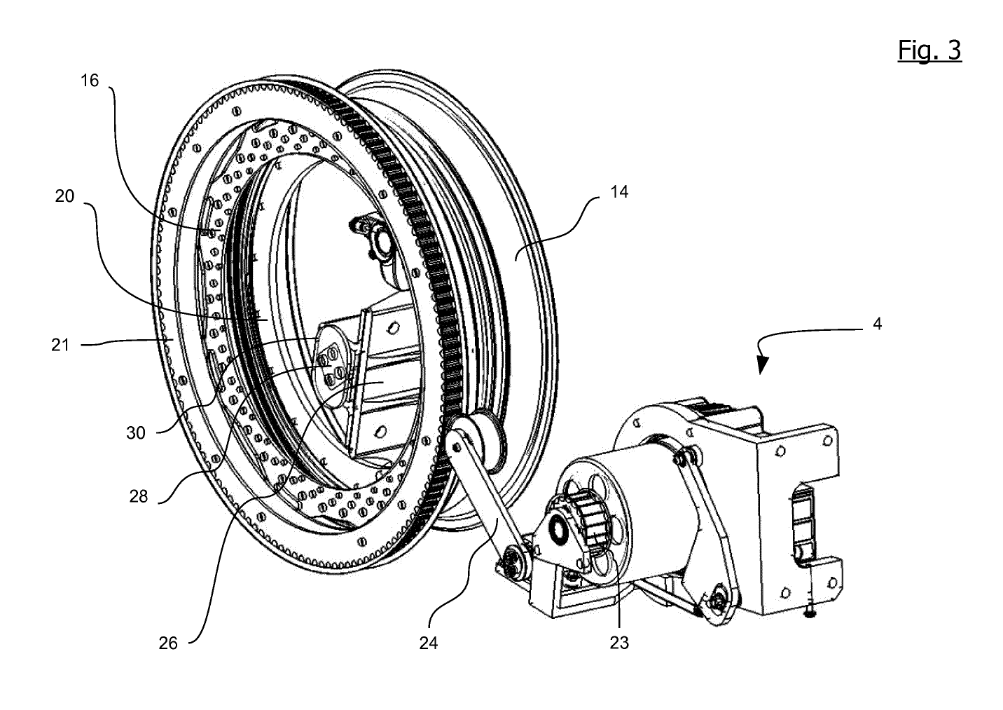

FIG. 3 shows the hubless rear wheel of a vehicle according to one embodiment with a drive unit and brake ring;

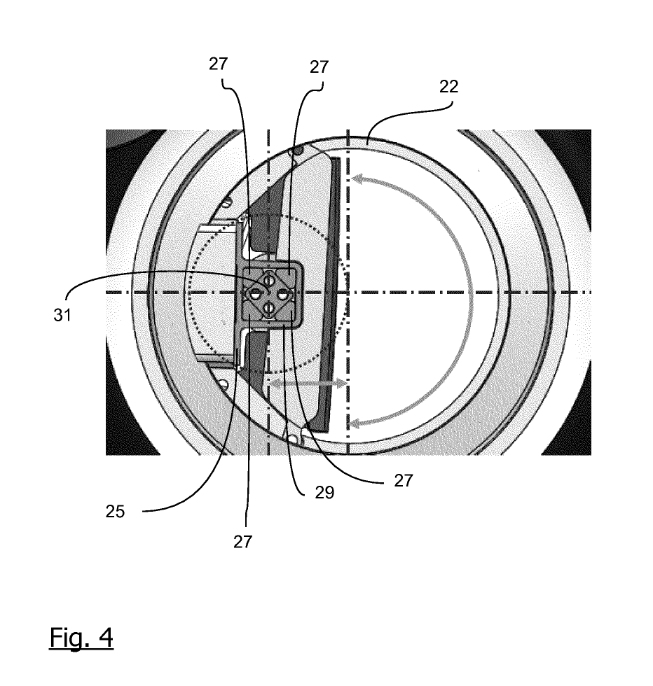

FIG. 4 shows the arrangement of a torsion elastic suspension element on the wheel mount (front wheel).

The motor-driven two-wheeled vehicle 1 consists of a chassis 2, a central unit 3, comprising the drive unit 4 in the embodiment, and, as it is designed as an electric vehicle there, a battery box 5, a seat carrier 6 with a driver's seat 7, as well as a cockpit structure 8, comprising a steering device with handlebar 9 and operating unit. The rear wheel mount 10 and the front wheel mount 11 are pivoted on the chassis 2. In the embodiment shown, for reasons of weight the rear and the front wheel mounts 10, 11 are designed as single-arm structures. However, it is perfectly conceivable that both the rear and the front wheel mounts—or, possibly just one of the two—can be designed to overlap the wheel(s) like a fork.

The rear wheel 12 and the front wheel 13 are designed as hubless structures—as a structure also known as a “Franco Sbarro centreless wheel”. In the embodiment, wheel bearing is carried out by means of a wheel bearing rim 20 or 22, which is attached to the wheel rim 14 or 15 in the shape of a ring. The wheel bearing rim 20, 22 is part of a bearing structure, which is well-known from automotive and/or mechanical engineering, known as a roller bearing (ball, roller, needle), where one of the rings of the roller bearing sits on the wheel rim and rotates with this, and the second ring is fixed to the wheel mount 10 or 11. With regard to this bearing, the structural details for the rear wheel bearing and the front wheel bearing correspond completely or at least to a large extent.

The brake ring arranged on the rim 16 or 17, which interacts with brake shoes (not shown) attached to the wheel mounts 10 or 11, are likewise broadly the same in structural terms on the rear wheel 12 or the front wheel 13. The design of the brake shoes corresponds in essence to the current state of the art.

FIG. 2 shows in detail the front single-arm wheel mount 11 with the actual wheel bearing 18 attached to it, which bears the toroidal wheel bearing rim of the roller bearing, which interacts via the roller bearing elements with the, likewise toroidal, second wheel bearing rim 22 attached to the wheel rim for the actual wheel bearing. To make conventional steering of such a two-wheeled vehicle with such a hubless wheel design possible, the notional line X=the axle line of the handlebar 19 should run through the likewise theoretical centre Z in the front wheel 13.

FIG. 3 shows the driven rear wheel rim 14 (shown without tyres). Attached to the wheel rim 14 is a wheel bearing rim 20, which interacts via the roller bearing elements interacting with it with the corresponding wheel bearing rim, which is attached to the rear wheel mount 10 (FIG. 1).

Likewise attached to the wheel rim 14 are a brake ring 16 and a toroidal gear ring 21 with external teeth by means of which the rear wheel is driven, e.g. by means of a pinion 23 of a drive unit 4, by means of a toothed belt. The oscillating compressing and extending wheel movements of the rear wheel 12 can be compensated for by means of a belt tensioner 24.

FIGS. 2, 3 and 4 show the suspension or damping design, according to some embodiments. By means of a mounting flange 25, 26 which is rigidly fixed to it, the wheel-bearing rim 20, 22 bears an element housing 29, 30, which may be attached to the mounting flange 25, 26 in one piece, having a basic rectangular shape and housing at least one torsion-elastic suspension element 27, 28. In the shown embodiment, in this element housing 29, 30 four suspension elements 27 are arranged under tension evenly in the corners of the rectangle by means of a core element 31, which is likewise essentially rod-shaped and substantially rigid e.g. made of steel. On the side facing the wheel mount 10, 11, the suspension core element 31 is attached to the wheel mount 10, 11 by means of a mounting flange (not shown). The initial tension or the decreasing or increasing tension of suspension elements 27 and element housing 29 with the suspension core element bring about suspension or damping with relative movements of the wheel in relation to the wheel mount 11 as a result of torsion forces acting on the torsion-elastic suspension element. Damping or suspension of the wheel can be selected or set via the arrangement of the suspension core element 31 in relation to the wheel bearing rim 22 together with the degree of elasticity and the dimensions of the suspension element(s) 27.

It is easy for the person skilled in the art to understand that different design solutions for drive as well as for wheel suspension and a suspension solution may be suitable.

### LIST OF REFERENCE NUMERALS

1 motor-driven two-wheeled vehicle
2 Chassis
3 Central unit
4 Drive unit
5 Battery box
6 Seat carrier
7 Driver's seat
8 Cockpit structure
9 Steering wheel
10 Rear wheel mount
11 Front wheel mount
12 Rear wheel
13 Front wheel
14 Rear wheel rim
15 Front wheel rim
16, 17 Brake ring
18 Wheel bearing
19 Handlebar
20 Rear wheel bearing rim
21 Toroidal gear ring
22 Front wheel bearing rim
23 Pinion
24 Belt tensioner
25 Front mounting flange
26 Rear mounting flange
27 Front suspension element
28 Rear suspension element
29 Front element housing
30 Rear element housing
31 Suspension core element
X=notional steering axis
Z=notional centre of the front wheel

1-17. (canceled)

18. A two-wheeled motor-driven vehicle comprising:
a chassis;
a central unit comprising a drive unit and a seat carrier;
a cockpit including a steering mechanism and an operating unit;
a front wheel carried on a front wheel mount and/or a rear wheel carried on a rear wheel mount, wherein the wheel mounts have a first toroidal wheel bearing rim, the first toroidal wheel bearing rim carrying, together with a second toroidal wheel bearing rim mountable to a wheel rim, the wheel rotatably via a roller bearing.

19. The two-wheeled motor-driven vehicle of claim 1, further comprising a torsion elastic suspension element arranged on the wheel bearing rim via a mounting flange.

20. The two-wheeled motor-driven vehicle of claim 19, wherein the torsion elastic suspension element comprises an element housing attached to the mounting flange and at least one essentially rod-shaped suspension element, and wherein the at least one essentially rod shaped element is placed under tension in the element housing.

21. The two-wheeled motor-driven vehicle of claim 20, wherein the element housing is attached to the mounting flange in one piece.

22. The two-wheeled motor-driven vehicle of claim 20, wherein the at least one essentially rod-shaped suspension element is arranged under tension in the element housing by means of an essentially rod-like suspension core element.

23. The two-wheeled motor-driven vehicle of claim 22, wherein on a side of the at least one essentially rod-shaped suspension element facing the front and/or rear wheel mount, the suspension core element is provided with a mounting flange for mounting the suspension core element on the front and/or rear wheel mount.

24. The two-wheeled motor-driven vehicle of claim 23, wherein damping of the front wheel or the rear wheel is adjustable by way of an arrangement of the suspension core element in relation to the wheel bearing rim of the front or rear wheel, along with a degree of elasticity and dimensions of the rod-shaped suspension element.

25. The two-wheeled motor-driven vehicle of claim 18, wherein the steerable front wheel is connected via a support element attached to the toroidal rim-sided wheel bearing rim, to the wheel mount steerable by the steering mechanism such that a steering axis runs through a centre of the wheel.

26. The two-wheeled motor-driven vehicle of claim 18, further comprising a brake ring attached to the wheel rim and arranged as brake disc, wherein the brake ring interacts with a brake-shoe is mountable to the front or rear wheel mount.

27. The two-wheeled motor-driven vehicle of claim 18, wherein the rear wheel has an essentially toroidal drive section, mountable to the wheel rim, and drivable by the drive unit directly or indirectly.

28. The two-wheeled motor-driven vehicle of claim 27, wherein the drive of the toroidal drive section is carried out via a gearbox construction, which compensates oscillating movements of the rear wheel.

29. The two-wheeled motor-driven vehicle of claim 27, wherein the drive section is an essentially toroidal gear ring drivable by the drive unit by way of a toothed belt.

30. The two-wheeled motor-driven vehicle of claim 27, wherein the drive section is an essentially toroidal sprocket ring drivable by the drive unit by way of a chain.

31. The two-wheeled motor-driven vehicle of claim 18, wherein the vehicle is a scooter.

32. The two-wheeled motor-driven vehicle of claim 18, wherein the vehicle is made to be foldable.

33. The two-wheeled motor-driven vehicle of claim 18, wherein the vehicle is drivable by a fully electric drive.

34. The two-wheeled motor-driven vehicle of claim 18, wherein at least one of the chassis, central unit, cockpit structure, and wheel mounts are made from fibre-reinforced plastics.
